(19) United States
(12) Patent Application Publication
(10) Pub. No.: US 2021/0207571 A1
(43) Pub. Date: Jul. 8, 2021

(54) TIDAL POWER GENERATING SYSTEM

(71) Applicant: Byungki YOU, Seoul (KR)

(72) Inventor: Byungki YOU, Seoul (KR)

(21) Appl. No.: 16/067,520

(22) PCT Filed: Sep. 30, 2016
(86) PCT No.: PCT/KR2016/011026

§ 371 Date: Jun. 29, 2018

(30) Foreign Application Priority Data
Dec. 29, 2015 (KR) 10-2015-0188341

(51) Int. Cl. F03B 13/26; F03B 11/00; E02B 9/08; E02B 5/08; E01D 19/02

(52) U.S. Cl. CPC F03B 13/26; F03B 11/00; E01D 19/02; E02B 5/08; E02B 9/08

(57) ABSTRACT

The present invention relates to a tidal power generating system for blocking paths through which seawater passes at points where there is a difference between the ebb and flow of the tide, so as to create a strong water current and use the water current to generate electricity.

### TECHNICAL FIELD

The present invention relates to a tidal power generating system and more specifically, to a tidal power generating system in which paths through which seawater passes are blocked at points where there is a tidal difference so as to create strong water currents and use the water currents to generate electricity.

### RELATED ART

In general, a variety of energy sources ranging from fossil fuels such as coal and petroleum to water power, tidal power, nuclear power, solar power, wind power, and to biofuels etc. are used to generate electricity. However, nuclear energy is inherently unsafe. Accordingly, there is always a strong backlash against the construction of nuclear power plants from residents living nearby when a place is designated as a site for a nuclear power plant. Further, in terms of nuclear power plants, even minor mistakes can cause fatal accidents such as the Chernobyl disaster in Russia and the Fukushima disaster in Japan that took many people's lives.

Further, there is also a problem with hydroelectric and tidal power generating systems in which tide embankments are installed. The problem is that the placement of a tide embankment has a considerable effect on the quality of water and the ecosystem of rivers and sea. In addition, solar power generating systems are not cost competitive compared to other electricity generating systems. In particular, South Korea does not have an abundant supply of wind energy. Accordingly, there are only a small number of sites appropriate for wind power generating facilities. Further, people complain that wind power stations cause too much noise.

Against this backdrop, although some have suggested tidal power generating systems which are suitable for South Korea where there a big tidal difference, such tidal power generating systems are not widely distributed due to a lack of benefits from and promotion of the construction of such systems.

### DETAILED DESCRIPTION OF THE INVENTION

### Technical Problems

The present invention provides a tidal power generating system which maximizes flow velocity of sea water when there are flood and ebb currents four times a day and which rotates a power transfer shaft (waterwheel) so as to generate electricity thereby providing an environmentally friendly power generating facility with incurring costs of purchasing raw materials. Further, the present invention provides a tidal power generating system which does not store water so as not to cause water pollution thereby having no harmful effect on the ecosystem.

### Technical Solutions

As a means to achieve the above-described purposes, a tidal power generating system includes a plurality of buoyancy rooms which are installed in a direction perpendicular to tidal waves and spaced apart from one another at regular intervals such that tidal waves pass through spaces between the intervals; impellers which are installed to protrude in the lateral direction of the buoyancy rooms so as to be rotated by the tidal waves passing through the spaces between the buoyancy rooms; impeller guide means elevating and lowering the impellers in the perpendicular direction according to high and low water levels; generators which generate electricity by using rotation forces of the impellers and connect with the impellers through power transfer means; and generator elevating means which elevate and lower the generators in the perpendicular direction according to high and low water levels.

According to a feature of the present invention, the generator elevating means are buoyancy bodies elevated and lowered inside the buoyancy rooms 1 by means of buoyancy, and the generators 31 are installed in the buoyancy rooms 1 and may be fixedly installed at the upper surface of the buoyancy body 20.

According to another feature of the present invention, some of the spaces between the buoyancy rooms may be used as a seaway.

According to yet another feature of the present invention, a standing structure constituting the buoyancy room may be configured to be a concrete structure.

According to yet another feature of the present invention, a bridge may be installed on the upper surfaces of the buoyancy rooms such that the buoyancy rooms 1 are used as a pier.

According to yet another feature of the present invention, the standing structure constituting the buoyancy room may be configured to have a slim plane shape to reduce resistance of tidal currents.

### Advantageous Effects

With the above-described configuration, provided is power generating systems using clear energy sources, which cause no environmental pollution, water pollution. Additionally, according to an embodiment of the present invention, a power generating system may be also used as a road (bridge) for connecting a land and a land. The detailed effects will be described as follows.

While there is always a strong backlash against the construction of nuclear power stations, coal power stations and hydroelectric power stations from residents living nearby when a place is designated as a site for such power stations due to their potential harmful effects on the environment and local residents' lives, the present invention which causes no environmental pollution, water pollution. Further, the present invention helps preserve the marine environment, protect the livelihood of residents in fishing villages and reduce about 8.82 million tons of greenhouse gas emissions per year in South Korea. The present invention may be also used as a road (bridge) for connecting a land and a land. Only a small amount of capital is needed to build a power generating facility because a power generating facility may be built with government budgets and the toll of the road built on the power generating facility is payable by those who use the road as a means to cover the construction cost. Accordingly, the capital invested in building the power generating facility may be returned for a short period of time.

The present invention may serve as tourism infrastructure that can attract many people thereby helping activate the local economy, improving the quality of life of local residents, providing economic benefits to local residents. Further, the present invention does not incur a vast amount of construction costs compared to existing power generating systems and the capital invested in building the present invention may be returned for a short period of time. Afterwards, a nation generating a huge amount of electricity by using the present invention which makes use of energy sources such as tidal waves for free can become an electricity exporter that can make massive profits.

### BRIEF DESCRIPTION OF THE INVENTION

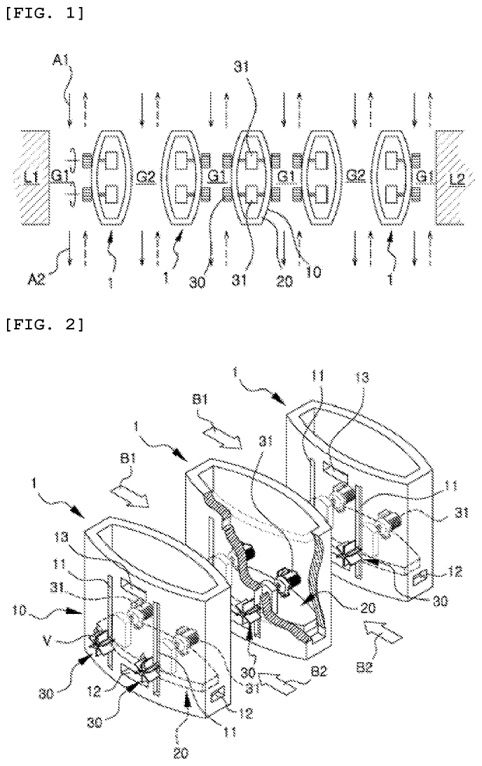

FIG. 1 is a block diagram illustrating a plane of a tidal power generating system according to an embodiment of the present invention.

FIG. 2 is a schematic perspective view illustrating a part of a tidal power generating system according to an embodiment of the present invention.

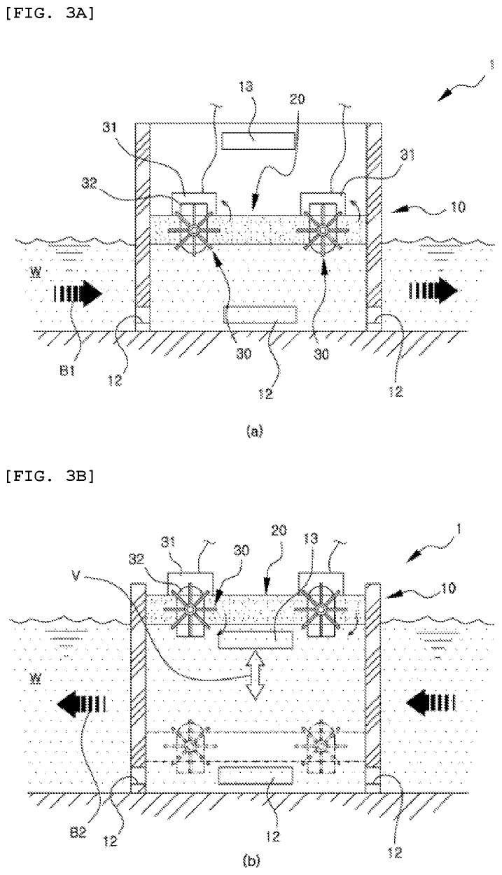

FIGS. 3A and 3B are block diagrams illustrating a lateral cross section of a buoyancy room of a tidal power generating system according to an embodiment of the present invention.

FIG. 4 is a block diagram illustrating a front of a tidal power generating system according to an embodiment of the present invention.

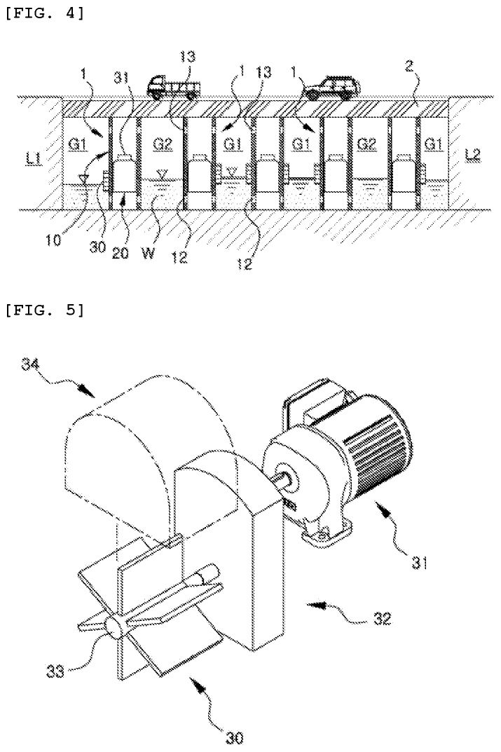

FIG. 5 is a block diagram illustrating an impeller and a generator of a tidal power generating system according to an embodiment of the present invention.

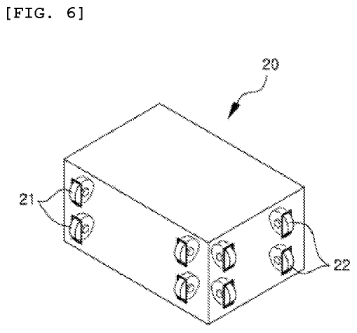

FIG. 6 is a perspective view illustrating a buoyancy body of a tidal power generating system according to an embodiment of the present invention.

### BEST MODE FOR CARRYING OUT THE INVENTION

The present invention provides a tidal power generating system including: a plurality of buoyancy rooms which are installed in a direction perpendicular to tidal waves and spaced apart from one another at regular intervals such that tidal waves pass through spaces between the intervals; impellers which are installed to protrude in the lateral direction of the buoyancy rooms so as to be rotated by the tidal waves passing through the spaces between the buoyancy rooms; impeller guide means elevating and lowering the impellers in the perpendicular direction according high and low water levels; generators which generate electricity by using rotation forces of the impeller and connect with the impeller through power transfer means; and generator elevating means which elevate and lower the generators in the perpendicular direction according to high and low water levels.

### MODE FOR CARRYING OUT THE INVENTION

Below, embodiments of the present invention will be described in detail with reference to the attached drawings. Embodiments of the present invention will be described with reference to FIGS. 1 to 3A, 3B, and if necessary, other drawings will be cited.

The present invention relates to a tidal power generating system using ebb and flood currents, which is installed at marine places where there is a tidal difference. The present invention relates to a system which allows ebb and flood currents to fast flow so as to operate a generator by using power generated by the fast flowing ebb and flood currents.

A tidal power generating system of the present invention includes buoyancy rooms 1, impellers 30, and generators 31.

The buoyancy room 1 is configured to be a plurality of ones which are installed in a direction perpendicular to tidal waves and spaced apart from one another at regular intervals such that tidal waves pass through spaces G1, G2 between the intervals.

For instance, the buoyancy rooms 1 are regularly spaced apart from one another at eight-meter intervals, and the height of the buoyancy room is proportionate to a tidal difference and is determined on the basis of expected typhoons or tidal waves.

The buoyancy rooms 1 are preferably installed between both banks L1, L2 through which tidal waves pass. Flow velocity of tidal waves A1, A2 flowing between the banks L1, L2 gets faster by means of the buoyancy rooms 1. This is because a path through which sea water passes gets narrower. The buoyancy rooms 1 allow sea water to fast flow and to flow from the bay out to sea for a lengthened period of time, thereby making it possible to generate electricity for a longer period of time.

The buoyancy room 1 includes a container-shaped standing structure 100 and various devices installed inside the container-shaped standing structure. The plane of the standing structure 10 may be configured to be slim to reduce resistance of tidal currents. The standing structure 10 may be configured to have an oval shape or to have a long polygon shape as illustrated. The standing structure 10 may be made from reinforce concrete. The standing structure 10 has gates 12 which are formed at the lower portion of the standing structure to allow sea water to flow into and out of the buoyancy room 1. The buoyancy room may have a discharge mouth 13 which is formed at the upper portion of the buoyancy room to allow sea water to overflow when there is much seawater. The buoyancy room may further have a sea water inflow mouth (invisible) in the direction which the buoyancy room 1 faces tidal waves so as to reduce the resistance of the buoyancy room 1 when a huge wave rushes in. The gate 12, as illustrated, may be prepared in different directions of the buoyancy room 1 because water has to be introduced smoothly.

Some G2 of the spaces between the buoyancy rooms 1 may be used as a seaway. Further, a bridge 2 may be installed on the upper surfaces of the buoyancy rooms 1 such that the buoyancy rooms 1 are used as a pier (see FIG. 4).

The impellers 30 are installed to protrude in the lateral direction of the standing structure 10 so as to be rotated by the tidal waves passing through the spaces between the buoyancy rooms 1. One third of the impeller 30 is always submerged into the sea. To this end, the impellers 30 has to be installed to move up and down according to flood currents B1 and ebb currents B2. Impeller guide means, which elevate and lower the impellers 30 in the perpendicular direction V according high and low water levels, include guide grooves 11 which are perpendicularly formed at a lateral wall of the standing structure 10. Preferably, the impellers 30 are installed at places where there is no seaway for safety. However, the impellers may be installed if safety systems are prepared.

The generators 31 which generate electricity by using rotation forces of the impeller 30 are installed at the buoyancy room 1. The generators 31 connect with the impeller 30 through power transfer means. The power transfer means 32 may be a gear, a chain, a belt etc. The power transfer means are installed in the shape of a water-resistant box.

Like the impellers 30, the generators 31 also have to be elevated and lowered in the perpendicular direction V according to high and low water levels. Generator elevating means elevate and lower the generators 31 according to flood currents B1 and ebb currents B2. The generator elevating means may be buoyancy bodies 20 elevated and lowered inside the buoyancy rooms 1 by means of buoyancy. The generators 31 are installed in the buoyancy rooms 1 and may be fixedly installed at the upper surface of the buoyancy body 20.

EPS or a hollow body may be used as the buoyancy body 20 which is configured to be a structure floating on sea water by means of buoyancy. Rollers 21, 22 for reducing friction may be installed on outer walls of the buoyancy body 20 such that the buoyancy body 20 smoothly moves up and down inside the buoyancy room 1 (see FIG. 6). The rollers 21, 22 roll against inner walls of the standing structure 10 so as to allow the buoyancy body 20 to smoothly move perpendicularly. Guide means such as a rail may be further prepared so as to allow the buoyancy body 20 to move up and down inside the buoyancy room 1 in a stable manner.

Additionally, the rotation direction of the impellers 30 changes periodically according to flood or ebb currents so as to generate electricity. A cover 34 may covers up the impeller 30 to prevent the rotation forces from being offset by waves which rush in while the impeller rotates (see FIG. 5). The cover 34 wraps the upper portion of the rotation shaft 33 of the impeller to prevent waves from hitting the upper portion of the impeller 30.

The above-described embodiments have been provided as examples on the basis of the technical idea of the present invention. One skilled in the art to which the present invention pertains may carry out modifications by making use of the examples without departing from the spirit and scope of the present invention described in the appended claims and may freely combine all the described embodiments to carry out the invention. However, it should be understood that any modification and combination are construed as being included in the scope of the right to the present invention.

### INDUSTRIAL APPLICABILITY

The present invention is applicable to a field relating to a tidal power generating system which maximizes flow velocity of sea water when there are flood and ebb currents four times a day and rotates a power transfer shaft (waterwheel) so as to generate electricity thereby providing an environmentally friendly power generating facility with incurring costs of purchasing raw materials. Further, the present invention provides a tidal power generating system which does not store water so as not to cause water pollution thereby having no harmful effect on the ecosystem.

1. A tidal power generating system comprising:
a plurality of buoyancy rooms which are installed in a direction perpendicular to tidal waves and spaced apart from one another at regular intervals such that tidal waves pass through spaces between the intervals;
impellers which are installed to protrude in lateral directions of the buoyancy rooms so as to be rotated by the tidal waves passing through the spaces between the buoyancy rooms;
impeller guide means elevating and lowering the impellers in the perpendicular direction according to high and low water levels;
generators which generate electricity by using rotation forces of the impellers and connect with the impellers through power transfer means; and
generator elevating means which elevate and lower the generators in the perpendicular direction according to high and low water levels.

2. The tidal power generating system according to claim 1, wherein the generator elevating means are buoyancy bodies elevated and lowered inside the buoyancy rooms by means of buoyancy,
the generators are installed in the buoyancy rooms and are fixedly installed at the upper surface of the buoyancy body.

3. The tidal power generating system according to claim 1, wherein some of the spaces between the buoyancy rooms are used as a seaway.

4. The tidal power generating system according to claim 1, a standing structure constituting the buoyancy room is configured to be a concrete structure.

5. The tidal power generating system according to claim 1, wherein a bridge is installed on the upper surfaces of the buoyancy rooms such that the buoyancy rooms are used as a pier.

6. The tidal power generating system according to claim 1, wherein a standing structure constituting the buoyancy room is configured to have a slim plane shape to reduce resistance of tidal currents.
